(19) United States
(12) Patent Application Publication
(10) Pub. No.: US 2016/0152179 A1
(43) Pub. Date: Jun. 2, 2016

(54) DASHBOARD ILLUMINATION FOR A VEHICLE

(71) Applicant: INTERNATIONAL BUSINESS MACHINES CORPORATION, Armonk, NY (US)

(72) Inventor: David GAULD, Hampshire (GB)

(21) Appl. No.: 14/951,794

(22) Filed: Nov. 25, 2015

(30) Foreign Application Priority Data
Nov. 27, 2014 (GB) 1421037.1

(51) Int. Cl. B60Q 3/04; B60R 11/04; H05B 37/02; G06K 9/00

(52) U.S. Cl. CPC B60Q 3/048; G06K 9/00604; B60R 11/04; H05B 37/0218; H05B 37/0227

(57) ABSTRACT

A dashboard illumination system for a vehicle. The system is for a dashboard with an illumination system capable of providing at least a low level and a high level of illumination of the dashboard. A camera is positioned so that it can capture an image containing the eyes of a driver of the vehicle, and an image processor is in communication with the camera to determine, using the image(s) captured by the camera, whether the driver's eyes are directed towards the dashboard of the vehicle. A control system is in communication with the illumination system, and the control system, in response to the image processor indicating that the driver's eyes are directed towards the dashboard of the vehicle, instructs the illumination system to provide the high level of illumination of the dashboard.

### PRIOR FOREIGN APPLICATION

This application claims priority from United Kingdom (GB) patent application number 1421037.1, filed Nov. 27, 2014, which is hereby incorporated herein by reference in its entirety.

### BACKGROUND

The present invention concerns a dashboard illumination system for a vehicle, and a method of controlling an illumination system of a dashboard of a vehicle.

Vehicle dashboard illumination systems, such as car dashboard lights, can be a distraction to drivers when driving in the dark. As these lights are often too bright, they can cause the driver to not fully concentrate on the road in front of them.

A solution to this problem is to have a brightness control (or “dimmer”) switch, which allows the driver to manually increase or decrease the brightness of the dashboard lights to allow a distraction-free driving experience. However, a drawback of this solution is that the manual operation of the brightness control switch itself results in a distraction to the driver, since it requires the driver to take their eyes off of the road to operate the switch.

### SUMMARY

The present invention seeks to solve and/or mitigate some or all of the above-mentioned disadvantages. Alternatively and/or additionally, the present invention seeks to provide an improved dashboard illumination system for a vehicle, and an improved method of controlling an illumination system of a dashboard of a vehicle.

In one or more aspects, a dashboard illumination system for a vehicle is provided, which includes: a dashboard comprising an illumination system, wherein the illumination system provides at least a low level or a high level of illumination of the dashboard; a camera positioned to capture an image containing eyes of a driver of the vehicle; an image processor in communication with the camera, wherein the image processor uses the image captured by the camera and determines whether the driver's eyes are directed towards the dashboard of the vehicle; and a control system in communication with the illumination system and the image processor, wherein the control system, in response to the image processor indicating that the driver's eyes are directed towards the dashboard of the vehicle, instructs the illumination system to provide the high level of illumination of the dashboard.

In one or more other aspects, a method of controlling an illumination system of a dashboard of a vehicle is provided. The method includes: capturing with a camera an image containing eyes of a driver of the vehicle; determining using the captured image whether the driver's eyes are directed towards the dashboard of the vehicle; and based on determining the driver's eyes are directed towards the dashboard of the vehicle, automatically instructing the illumination system to provide a high level of illumination of the dashboard, wherein the illumination system provides at least a low level or the high level of illumination of the dashboard.

In one or more further aspects, a computer program product for controlling an illumination system of a dashboard of a vehicle is provided. The computer program product includes a computer readable storage medium having program instructions embodied therewith, the program instructions being executable by a processor to cause the processor to perform a method comprising: capturing with a camera an image containing eyes of a driver of the vehicle; determining using the captured image whether the driver's eyes are directed towards the dashboard of the vehicle; and based on determining that the driver's eyes are directed towards the dashboard of the vehicle, automatically instructing the illumination system to provide a high level of illumination of the dashboard, wherein the illumination system provides at least a low level or the high level of illumination of the dashboard.

### BRIEF DESCRIPTION OF THE DRAWINGS

Embodiments of the present invention are described below, by way of example only, with reference to the drawings, in which:

FIG. 1 shows a dashboard illumination system, in accordance with one or more aspects of the present invention;

FIG. 2a is a schematic diagram of the front portion of a vehicle, showing the eyes of a driver of a vehicle directed away from the dashboard of the vehicle, which has a dashboard illumination system, in accordance with one or more aspects of the present invention;

FIG. 2b is a schematic diagram of the front portion of the vehicle of FIG. 2a, showing the eye(s) of the driver directed towards the dashboard with the dashboard illumination system, in accordance with one or more aspects of the present invention;

FIG. 3 is a flowchart showing operation of a control system of a dashboard illumination system, in accordance with one or more aspects of the present invention;

FIG. 4 shows an alternate embodiment of a dashboard illumination system, in accordance with one or more aspects of the present invention;

FIG. 5 is a schematic diagram of a front portion of a vehicle having a dashboard illumination system, in accordance with one or more aspects of the present invention; and

FIG. 6 is a further flowchart showing operation of a control system of a dashboard illumination system, in accordance with one or more aspects of the present invention.

### DETAILED DESCRIPTION

As noted, in accordance with one aspect of the present invention, a dashboard illumination system for a vehicle is provided, comprising: a dashboard having an illumination system, wherein the illumination system is capable of providing at least a low level and a high level of illumination of the dashboard; a camera positioned so that it can capture an image containing the eyes of a driver of the vehicle; an image processor in communication with the camera, wherein the image processor is arranged to determine using the image(s) captured by the camera whether the driver's eyes are directed towards the dashboard of the vehicle; a control system in communication with the illumination system and the image processor; wherein the control system is arranged, in response to the image processor indicating that the driver's eyes are directed towards the dashboard of the vehicle, to instruct the illumination system to provide the high level of illumination of the dashboard.

In this way, the high level of illumination of the dashboard can be provided when the driver's eyes are directed towards the dashboard, so that the dashboard can be properly viewed. However, when the driver is looking elsewhere, the low level of illumination can be provided, so the illumination does not distract the driver. Further, the change in illumination level happens without any physical interaction (as manual operation of a brightness control switch would require, for example) from the driver, so that does not present a further distraction.

The control system may be arranged, in response to the image processor indicating that the driver's eyes are not directed towards the dashboard of the vehicle, to instruct the illumination system to provide the low level of illumination of the dashboard. However, under certain conditions the control system may arranged to instruct the illumination system to provide the high level of illumination of the dashboard, despite the image processor indicating that the driver's eyes are not directed towards the dashboard of the vehicle.

Advantageously, the vehicle may be a road vehicle. Alternatively, the vehicle may be any other suitable type of vehicle, for example an airplane. The road vehicle may be a car, truck, or the like. Alternatively, the road vehicle may be a motorbike, scooter or the like.

In one or more embodiments, the camera may be mounted in the dashboard. Alternatively the camera may be mounted in any other suitable place, for example in the rear view mirror.

In one or more implementations, the control system may be in communication with the headlight system of the vehicle, and is arranged in response to the headlight system indicating that the headlights of the vehicle are not illuminated, to instruct the illumination system to provide the high level of illumination of the dashboard. This allows a suitable level of illumination to be provided when the headlights are not illuminated, which implies that there is a high level of ambient light. Alternatively, the dashboard illumination system may further comprise an ambient light sensor, wherein the control system is in communication with the ambient light sensor, and is arranged in response to the ambient light sensor indicating that the level of ambient light is above a predetermined threshold, to instruct the illumination system to provide the high level of illumination of the dashboard. In such a case, the ambient light sensor may be mounted in the dashboard. The use of an ambient light sensor may provide a more reliable system for determining the ambient light level, but requires additional components.

In accordance with a another aspect of the invention, a method of controlling an illumination system of a dashboard of a vehicle is provided, wherein the illumination system is capable of providing at least a low level and a high level of illumination of the dashboard, the method comprising: capturing with a camera an image containing the eyes of a driver of the vehicle; determining using the captured images whether the driver's eyes are directed towards the dashboard of the vehicle; in response to determining that the driver's eyes are directed towards the dashboard of the vehicle, instructing the illumination system to provide the high level of illumination of the dashboard.

In one or more embodiments, the camera may be mounted in the dashboard.

In one or more embodiments, the method may further comprise: determining whether the headlights of the vehicle are illuminated; in response to determining that the headlights of the vehicle are not illuminated, instructing the illumination system to provide the high level of illumination of the dashboard.

Alternatively, the method may further comprise: determining the level of ambient light within the vehicle; in response to the level of ambient light being above a predetermined threshold, instructing the illumination system to provide the high level of illumination of the dashboard. In this case, preferably the level of ambient light is determined by an ambient light sensor mounted in the dashboard.

In accordance with a further aspect of the invention, there is provided a computer program product for a dashboard illumination system for a vehicle, the computer program product comprising a computer-readable storage medium having computer-readable program code embodied therewith, the computer-readable program code configured when executed on a computer system to provide any of the dashboard illumination systems described herein.

In accordance with another aspect of the invention, there is provided a computer program product for a dashboard illumination system for a vehicle, the computer program product comprising a computer-readable storage medium having computer-readable program code embodied therewith, the computer-readable program code being configured to perform any of the methods described herein.

It will of course be appreciated that features described in relation to one aspect of the present invention may be incorporated into other aspects of the present invention. For example, the method of the invention may incorporate any of the features described with reference to the apparatus of the invention and vice versa.

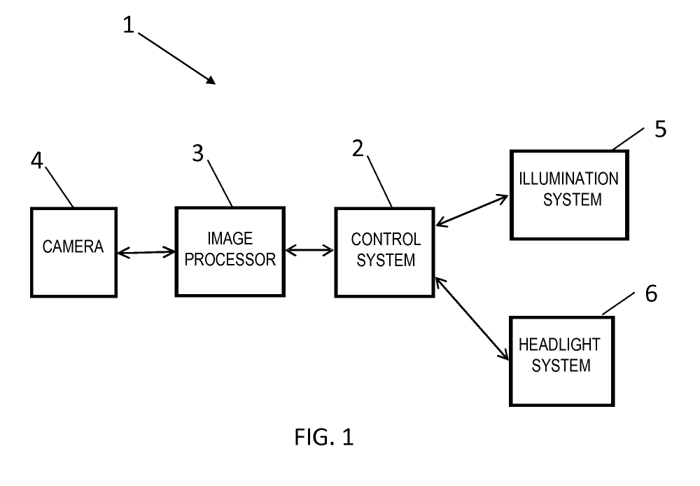

A dashboard illumination system in accordance with an embodiment of the invention is shown in FIG. 1. The dashboard illumination system 1 is for a dashboard of a vehicle, for example a car.

Dashboard illumination system 1 comprises a control system 2, which is in communication with an image processor 3. The image processor 3 is in turn in communication with a camera 4. The control system 2 is also in communication with an illumination system 5 of the dashboard of the car, and the headlight system 6 of the vehicle.

The illumination system 4 is able to provide variable levels of illumination of the dashboard, by brightening/dimming the light sources (for example LEDs) it uses to illuminate the dashboard. In particular, the dashboard is able to provide at least a low level of illumination, say where the light sources are dimmed to a level of around 10-20%, and a high level of illumination, say where the light sources are brightened to a level of around 90-100%.

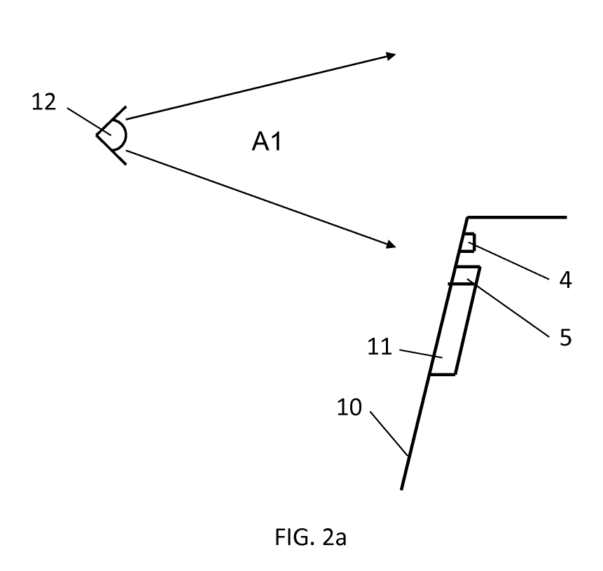

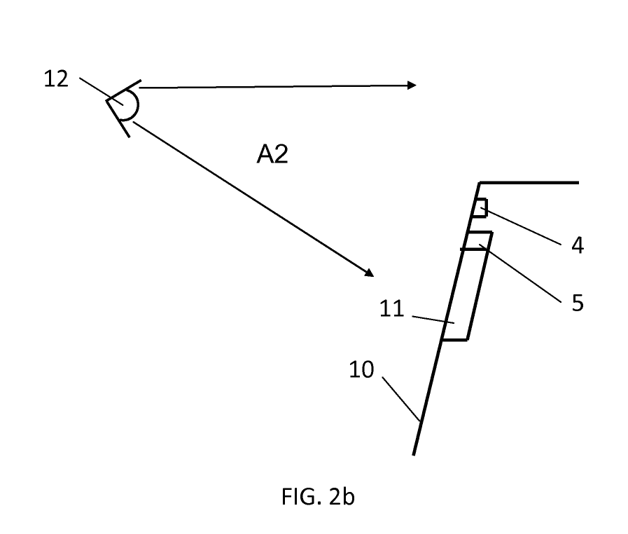

FIG. 2a is a schematic diagram showing a partial dashboard of the vehicle, and the eyes of a driver of the vehicle. The front portion 10 of the body of the vehicle has mounted within it the dashboard 11, which comprises the illumination system 5. Also mounted within the front body portion 10 is the camera 4.

As can be seen, in this case the eyes 12 of the driver are directed over the top of the dashboard 11, so for example, in the case that the vehicle is a car, the driver is looking through the windscreen at the road. The direction of view of the driver is shown by the arrows enclosing the area A1. The camera 4 is positioned so that an image it captures will contain an image of the eyes 12 of the driver.

In FIG. 2b, the eyes 12 of the driver are directed towards the dashboard 11, as shown by the arrows enclosing the area A2.

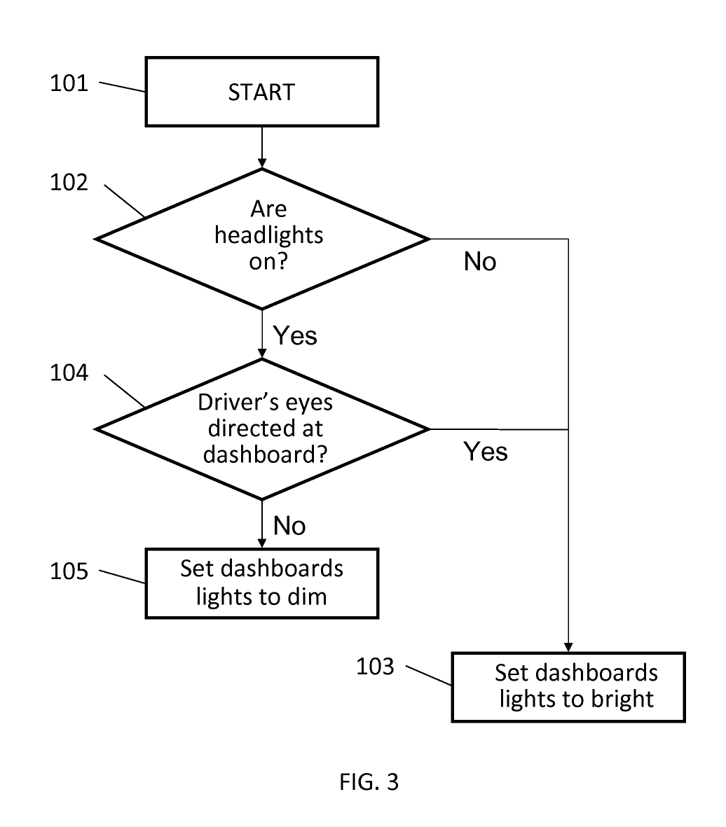

One embodiment of the operation of the control system 2 of the dashboard illumination system 1 is depicted in FIG. 3. Referring to FIGS. 1-3, after the control system 2 is initialized (step 101), it checks with the headlight system 6 whether the headlights of the vehicle are switched on (step 102). If the headlights are not switched on, the control system 2 instructs the illumination system 5 to provide the high level of illumination of the dashboard 11 (step 103). This is because it is assumed if the headlights are not switched on that it is daytime and there is a high level of ambient light, so a high level of illumination of the dashboard 11 will not be distracting, and may also be required for the dashboard 11 to be properly visible to the driver.

If the headlights are not switched on, the control system 2 checks with the image processor 3 whether the driver's eyes 12 are directed towards the dashboard 11 (step 104). The image processor 3 determines whether this is the case by processing the images captured by the camera containing the images of the driver's eyes 12, using any suitable eye recognition algorithm. If the driver's eyes 12 are directed towards the dashboard 11 (e.g. as shown in FIG. 2b), then the control system 2 instructs the illumination system 5 to provide the high level of illumination of the dashboard 11 (step 103). This enables the dashboard 11 to be properly visible to the driver.

If the driver's eyes are not directed towards the dashboard 11 (e.g., as shown in FIG. 2a), the control system 2 instructs the illumination system 5 to provide the low level of illumination of the dashboard 11 (step 105). This prevents the illumination system 5 from distracting the driver when they are not looking at the dashboard 11, and so the dashboard 11 does not need to be properly visible to the driver.

Thus, it can be seen that with the dashboard illumination system 1, no physical interaction is required between the driver and the dashboard 11. Simply by the driver looking at the dashboard 11, this will indicate to the dashboard illumination system 1 that brightness of the dashboard should be increased, limiting distractions and ensuring the driver is able to focus their full attention on the road.

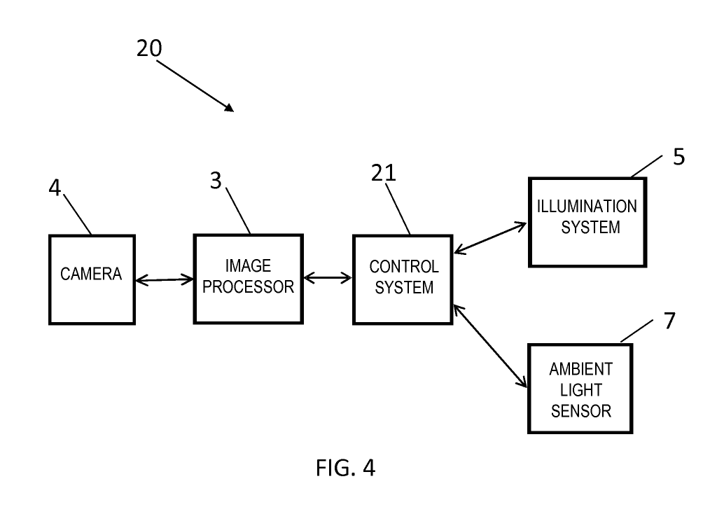

A dashboard illumination system in accordance with an alternative embodiment of the invention is depicted in FIGS. 4-6. As shown in FIG. 4, the dashboard illumination system 20 comprises a control system 21, which as in the previous embodiment is in communication with the image processor 3, which again is in turn in communication with the camera 4. Again as before, the control system 21 is also in communication with the illumination system 5 of the dashboard of the car. However, in this embodiment the control system 21 is not in communication with the headlight system of the vehicle, but rather with an ambient light sensor 7.

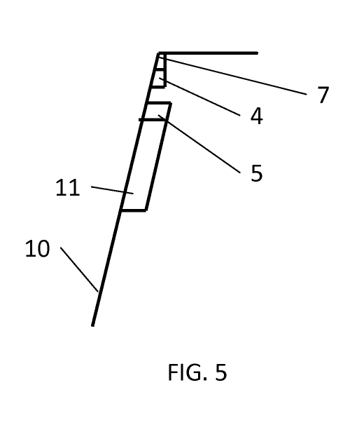

As shown in FIG. 5, in addition to the front portion 10 of the vehicle having mounted within it the dashboard 11 (comprising illumination system 5) and camera 4, the ambient light sensor 13 is mounted in the front portion 10.

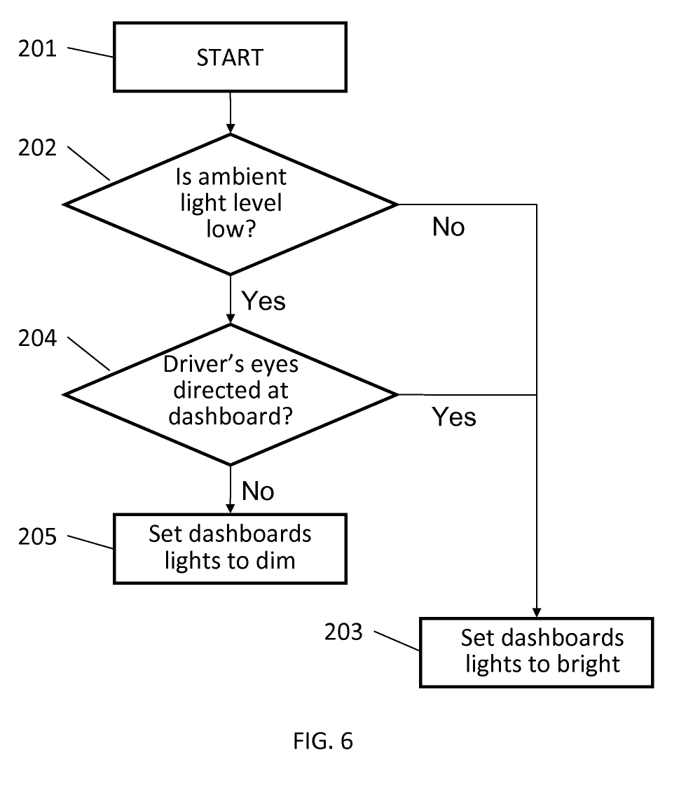

The operation of the control system 21 of the dashboard illumination system 20 can be described with reference to FIGS. 4-6. In this case, after the control system 21 is initialized (step 201, FIG. 6), it checks with the ambient light sensor 7 whether the ambient light level is below a predetermined threshold (step 202). If not, that there is a high level of ambient light, the control system 21 instructs the illumination system 5 to provide the high level of illumination of the dashboard 11 (step 203). If the ambient light level is above the predetermined threshold, then as in the previous embodiment, the control system 21 checks with the image processor 3 whether the driver's eyes 12 are directed towards the dashboard 11 (step 204); and if so, the control system 21 instructs the illumination system 5 to provide the high level of illumination (step 203 again), otherwise it instructs the illumination system 5 to provide the low level of illumination (step 204).

Thus, it can be seen that with the dashboard illumination system 20, provides the same advantages as the previous embodiment.

While the present invention has been described and illustrated with reference to particular embodiments, it will be appreciated by those of ordinary skill in the art that the invention lends itself to many different variations not specifically illustrated herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or control code written in any combination of one or more programming languages, including an control oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A dashboard illumination system for a vehicle, comprising:
a dashboard comprising an illumination system, wherein the illumination system provides at least a low level or a high level of illumination of the dashboard;
a camera positioned to capture an image containing eyes of a driver of the vehicle;
an image processor in communication with the camera, wherein the image processor uses the image captured by the camera and determines whether the driver's eyes are directed towards the dashboard of the vehicle; and
a control system in communication with the illumination system and the image processor, wherein the control system, in response to the image processor indicating that the driver's eyes are directed towards the dashboard of the vehicle, instructs the illumination system to provide the high level of illumination of the dashboard.

2. The dashboard illumination system of claim 1, wherein the camera is mounted in the dashboard.

3. The dashboard illumination system of claim 1, wherein the control system is in communication with a headlight system of the vehicle, and based on the headlight system indicating that the headlights of the vehicle are not illuminated, instructs the illumination system to provide the high level of illumination of the dashboard.

4. The dashboard illumination system of claim 1, wherein the dashboard illumination system further comprises an ambient light sensor, and wherein the control system is in communication with the ambient light sensor, and based on the ambient light sensor indicating that the level of ambient light is above a predetermined threshold, the control system instructs the illumination system to provide the high level of illumination of the dashboard.

5. The dashboard illumination system as claimed in claim 4, wherein the ambient light sensor is mounted in the dashboard.

6. A method of controlling an illumination system of a dashboard of a vehicle, the method comprising:
capturing with a camera an image containing eyes of a driver of the vehicle;
determining using the captured image whether the driver's eyes are directed towards the dashboard of the vehicle; and
based on determining that the driver's eyes are directed towards the dashboard of the vehicle, automatically instructing the illumination system to provide a high level of illumination of the dashboard, wherein the illumination system provides at least a low level or the high level of illumination of the dashboard.

7. The method of claim 6, wherein the camera is mounted in the dashboard.

8. The method of claim 6, further comprising:
determining whether the headlights of the vehicle are illuminated; and
based on determining that the headlights of the vehicle are not illuminated, instructing the illumination system to provide the high level of illumination of the dashboard.

9. The method of claim 6, further comprising:
determining a level of ambient light within the vehicle; and
based on the level of ambient light being above a predetermined threshold, instructing the illumination system to provide the high level of illumination of the dashboard.

10. The method of claim 9, wherein the level of ambient light is determined by an ambient light sensor mounted in the dashboard.

11. A computer program product for controlling an illumination system of a dashboard of a vehicle, a computer program product comprising:
a computer readable storage medium having program instructions embodied therewith, the program instructions being executable by a processor to cause the processor to perform a method comprising:
receiving from a camera an image containing eyes of a driver of the vehicle;
determining using the captured image whether the driver's eyes are directed towards the dashboard of the vehicle; and
based on determining that the driver's eyes are directed towards the dashboard of the vehicle, automatically instructing the illumination system to provide a high level of illumination of the dashboard, wherein the illumination system provides at least a low level or the high level of illumination of the dashboard.

12. The computer program product of claim 11, wherein the camera is mounted in the dashboard.

13. The computer program product of claim 11, further comprising:
determining whether the headlights of the vehicle are illuminated; and
based on determining that the headlights of the vehicle are not illuminated, instructing the illumination system to provide the high level of illumination of the dashboard.

14. The computer program product of claim 11, further comprising:
determining a level of ambient light within the vehicle; and
based on the level of ambient light being above a predetermined threshold, instructing the illumination system to provide the high level of illumination of the dashboard.

15. The computer program product of claim 14, wherein the level of ambient light is determined by an ambient light sensor mounted in the dashboard.
